(19) United States
(12) Patent Application Publication
(10) Pub. No.: US 2011/0041166 A1
(43) Pub. Date: Feb. 17, 2011

(54) Method of Password Assignment

(75) Inventor: Mahalingam Mani, Cupertino, CA (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/542,570

(22) Filed: Aug. 17, 2009

(51) Int. Cl. H04L 9/00

(52) U.S. Cl. 726/6

(57) ABSTRACT

A method is provided in which a user registers a Session Initiation Protocol (SIP) address with a server that uses digest access authentication; If the user has another address already registered with the server, the server requests the user name and password for the existing address. The user enters the user name and password into a client application. The client application transmits the user name and password to the registration server as clear text over an encrypted channel. The registration server generates a digest from the received user name and password and compares the generated digest with the digest stored on the registration server for the existing address in order to determine whether the user submitted a valid user name and password. If the generated and stored digests match, the registration server sets the password for the existing email account of the user as the password for the new email.

### FIELD OF THE INVENTION

The present invention relates to telecommunications in general, and, more particularly, to an improved method for assigning account passwords.

### BACKGROUND OF THE INVENTION

Authentication is the process of determining whether a person is, in fact, who the person declares to be. On the Internet, authentication is commonly accomplished through the use of a password. Knowledge of the password is assumed to guarantee that the identity of the submitter of the password is authentic.

For example, when a user wants to access his or her email, the user types a user name and password into an Internet browser. The Internet browser forwards this information to an authentication server. The authentication server determines whether the user name and password match, and if they do, the authentication server authorizes access to the email.

The manner in which the Internet Browser and the authentication server verify that the user name and password match is known as authentication model. A commonly used authentication method is “digest access authentication.” Digest access authentication is used in protocols, such as the Hypertext Transfer Protocol (HTTP) which powers the Internet, and the Session Initiation Protocol (SIP) which is used for the conduct of telephone calls over the Internet. Digest access authentication is described with specificity in Request for Comments 2617 (RFC 2617).

Generally, in digest access authentication, when a user wants to verify his or her identity with an authentication server, the server generates a random number called “nonce.” The server retains a copy of the nonce on the server side and forwards another copy to the user. After receiving the nonce at a client application, such as an Internet browser, the user enters a user name and password into the client application. The client application generates a primary “digest” which is based on the password and user name. Subsequently, the client application generates a secondary digest which is based on the nonce and the primary digest. After it is generated, the secondary digest is forwarded to the authentication server.

A “digest” is a string that is based on the user name and password. The string is obtained by executing a hashing algorithm which transforms the password and the user name” into a scrambled version of the user name and password. A benefit of scrambling the password into a digest is that if an unscrupulous person captures the digest while it is in transit to the authentication server, the unscrupulous person will be prevented from seeing the password.

It should be noted that because the secondary digest, which is transmitted over the network, contains a nonce, the secondary application cannot be captured by an unscrupulous person and reused later on. The nonce is unique to each authentication session and it expires shortly thereafter. If a user submits a hash to the authentication server which contains an expired nonce, the authentication server will detect that the nonce is expired, and will deny the authentication accordingly.

After the secondary digest is generated and transmitted by the client application, it is received at the authentication server. The authentication server calculates a verification digest by hashing the copy of the nonce which is retained at the server side with a base digest that is stored at the authentication sever. The authentication server, then, references the received secondary digest to the calculated verification digest. If the user entered a valid user name/password pair, the received secondary digest will be identical to the verification digest and the server will authenticate the user positively. If the received digest is not identical to the computed digest, the server will reject the user's request for authentication.

In other words, servers that use digest access authentication do not record passwords. Rather, the servers keep base digests that are derived from valid user name/password pairs. In order to authenticate a user name/password pair submitted by a user, it is sufficient for the servers to compute a verification digest from a stored base digest and dynamically generated nonce and compare the verification digest to a digest of the user name/password which is received from the user. Not keeping passwords on the servers eliminates the possibility that any passwords will be stolen from the servers and yields the benefit of heightened security.

However, not keeping the passwords on the servers can be a significant drawback in some situations.

### SUMMARY OF THE INVENTION

One such situation arises when a user desires to have multiple email addresses registered with the same email server. For example, the user could like to have a business email “user_business” that is used in relation to the user's employment and a second address “user_personal” that is used for exchange of emails of personal nature. Each of the email addresses is associated with a user ID and password which the user needs to remember in order to connect to the email server and read his or her mail.

However, keeping a different password for each email account can become burdensome and inconvenient for the user to a point at which the inconvenience outweighs the benefit of the heightened security resulting from using different passwords. Thus, when a user registers a new email account with a registration server, it is desirable to determine whether the user has another existing email account that is already registered with the server and set the password for the existing email account as the password for the new email account so that there is only one password for the individual to remember.

However, since servers that use digest access authentication do not keep records of passwords, but rather store digests that are based on mail username and passwords, the servers cannot retrieve the password for one email account and set it as the password for another email account. Therefore the need exists for a method that allows email, http or Session Initiation Protocol (SIP) servers that use digest access authentication to assign the same password to multiple email addresses (or accounts) registered with the servers.

The present invention answers this need by providing a method that avoids some of the costs and disadvantages of doing so in the prior art. When a user registers a new email address with an email server that uses digest access authentication, the server determines whether the user has an existing email account registered. If the user does, the server requests the user ID and password for the existing email account from the user. The user enters the user ID and password into a client application (i.e. the user's Internet browser). And the client application transmits the user ID and password to the registration server as clear text over an encrypted channel.

Upon receipt of the user ID and password, the registration server generates a digest from the received user ID and password. The registration server, then, compares the generated digest with the digest stored on the registration server for the existing address in order to determine whether the user submitted a valid user ID and password. If the user ID and password are valid, the registration server sets the password for the existing email account of the user as the password for the new email account.

Specifically, this illustrative embodiment of the present invention comprises: (i) receiving in response to a first request, a first user ID, a password, and a second user ID; and (ii) associating the second user ID with the password, if the first user ID and the password form a valid user ID/password pair.

In another illustrative embodiment of the present invention, when a user registers a new email account with a server that uses digest access authentication, the server determines whether the user has an existing email account registered. If the user does, the server requests the user ID and password for the existing email account from the user. The user enters the user ID and password into a client application (i.e. the user's Internet browser). The client application generates a first digest based on the user ID and password for the existing email account, and a second digest based on the user ID and password for the new email account, which the user is in the process of registering, and transmits the two digests to the registration server.

Upon receipt of the two digests, the registration server compares the first digest with the digest stored for the existing address in order to determine whether the user entered a valid user ID and password for the existing email account. If the user entered the correct user ID and password, the registration server associates the second digest with the new email account causing the password for the existing address to become the password for the new email account.

Specifically, this illustrative embodiment of the present invention comprises (i) receiving a first string and a second string, wherein the first string is based on: a first user ID, a password, and a hashing function; (ii) receiving a second string based on: a second user ID, the password, and the hashing function; and (iii) associating the second string with the second user ID, if the existing user ID and the first string form a valid user ID/string pair.

Although some embodiments of the present invention are described in the context of email account registration, it is to be understood that the uses and applications of the methods and principles described in this disclosure extend to all applications in which digest authentication is used. Moreover, although some embodiments of the present invention are described in the context of digest access authentication, it is to be understood that the uses and applications of the methods and principles described in which an authentication model is used in which the authentication servers have no access to user passwords.

### BRIEF DESCRIPTION OF THE DRAWINGS

FIG. 1 depicts a schematic diagram of the salient components of the illustrative embodiment of the present invention.

FIG. 2 depicts a flowchart of the salient tasks associated with the operation of the illustrative embodiment of the present invention.

FIG. 3 depicts a schematic diagram of the salient components of the illustrative embodiment of the present invention.

FIG. 4 depicts a schematic diagram of the salient components of the illustrative embodiment of the present invention.

FIG. 5 depicts a flowchart of the salient tasks associated with the performance of task 240.

FIG. 6 depicts a flowchart of the salient subtasks associated with the performance of task 520.

FIG. 7 depicts a flowchart of the execution of the salient sub-tasks associated with the performance of task 630 in accordance with a first illustrative embodiment of the present invention.

FIG. 8 depicts a flowchart of the execution of the salient tasks subtasks associated the performance of task 750.

FIG. 9 depicts a flowchart of the execution of the salient sub-tasks associated with the performance of task 630 in accordance with a second illustrative embodiment of the present invention.

### DETAILED DESCRIPTION

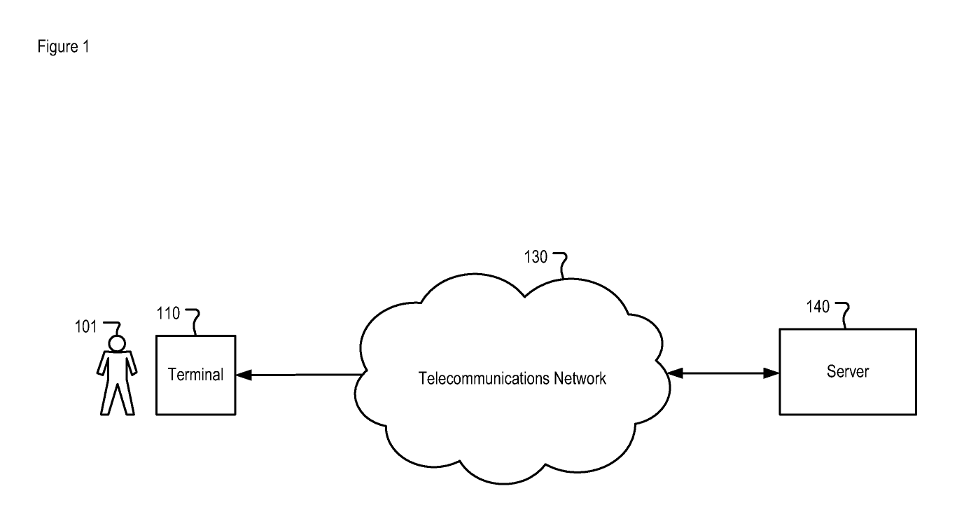

FIG. 1 depicts a schematic diagram of the salient components of the illustrative embodiment of the present invention. The illustrative embodiment comprises user 101, terminal 110, network 130, and server 140.

User 101 is a natural person using terminal 110. User 101 is the owner of an existing email account registered with server 140. Importantly user 101 possesses a user ID and a password associated with the existing email account. The user is able to use the user ID and password to connect to server 140 and manage the settings for the existing email account.

Terminal 110 is a personal computer that allows user 101 to connect to network 130 and use a Session Initiation Protocol (SIP) enabled telephony application. Furthermore, terminal 110 is capable of using a client application, such as a web browser, that allows user 101 to connect to server 140 and modify the settings for a Session Initiation Protocol (SIP) email account that is registered with server 140. Those skilled in the art will recognize, after reading this disclosure, how to make and use alternative embodiments of the present invention in which terminal 110 is another telecommunications device, such as, for example, and without limitation, a cellular telephone, portable digital assistant (PDA), etc.

Network 130 is a telecommunications network that transports signals between terminal 110, terminal 120, and server 140. In accordance with the illustrative embodiment of the present invention, network 130 is the Internet, but it will be clear to those skilled in the art, after reading this disclosure, how to make and use alternative embodiments of the present invention in which network 130 is another type of telecommunications network (e.g. a local area network, the Public Switched Telephone Network, a cellular telephone network, wide area network, etc.).

Server 140 is an email server that maintains a plurality of email accounts and provides users with a frontend interface for accessing and using their email accounts. In accordance with the illustrative embodiment, each email account registered with server 140 is associated with a user ID and a password. The user IDs and passwords, allow the owners of the emails to log onto server 140 to read their email or modify their email account settings. In other words, the purpose of the user IDs is to authenticate the owner of an email account before server 140, so that the owner can check his or her email and edit the email account settings.

Furthermore, it should be noted that each email account registered with server 140 is identified by an email account identifier. For example, for the email user 101 existing email@email server 140.com, the email identifier is the string “user_101_existing_email.” It will be clear to those skilled in the art, after reading this disclosure, how to make and use alternative embodiments of the present invention in which the email identifier is any alphanumerical string. In accordance with the illustrative embodiment of the present invention, the user IDs associated with the email accounts that are registered with server 140 are the same as the identifiers for those, but it will be clear to those skilled in the art how to make and u se alternative embodiments of the present invention in which the User IDs and identifiers are different.

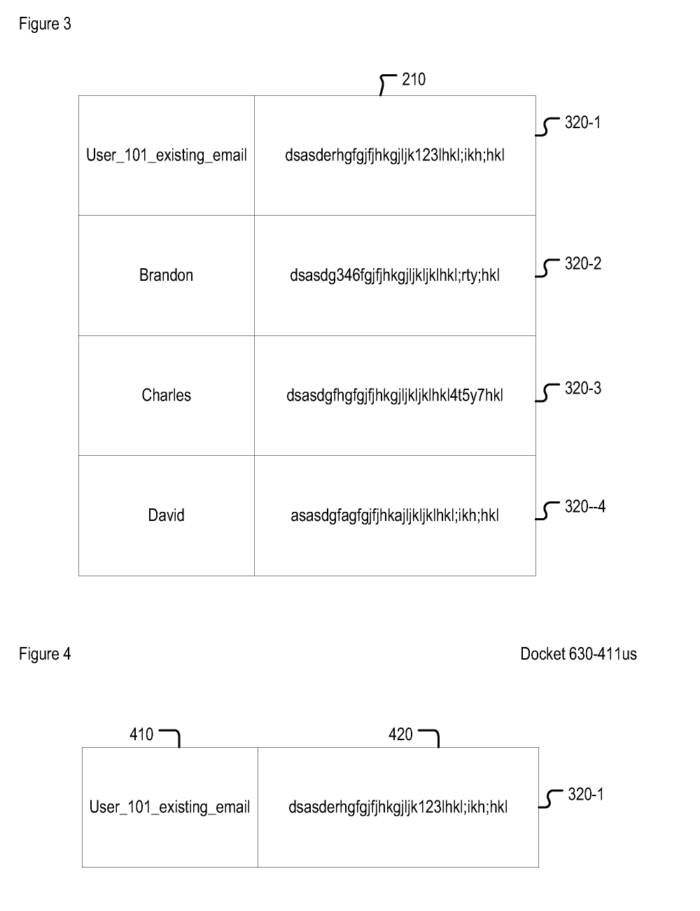

Server 140 uses digest access authentication for the processing of the user ID and password that are associated with the email accounts registered with server 140. The server stores a digest based on the user ID and password in database table 310. Database table 310 is further described in the discussion with respect to FIG. 3.

In accordance with the illustrative embodiment of the present invention, server 140 is an email server, but it will be clear to those skilled in the art, after reading this disclosure, how to make and use alternative embodiments of the present invention in which server 140 is any other device that needs to use a user ID/password authentication mechanism, such as, for example, and without limitation, a domain name server (DNS), Session Initiation Protocol (SIP) registrar, private branch exchange (PBX) server, etc.) Furthermore, in accordance with the illustrative embodiment, the identifiers resolved by server 140 are email user IDs, but it will be clear to those skilled in the art, after reading this disclosure, how to make and use alternative embodiments of the present invention in which the identifiers are domain names, email addresses, telephone numbers, instant messenger names, telephone extension numbers, telephone numbers etc.

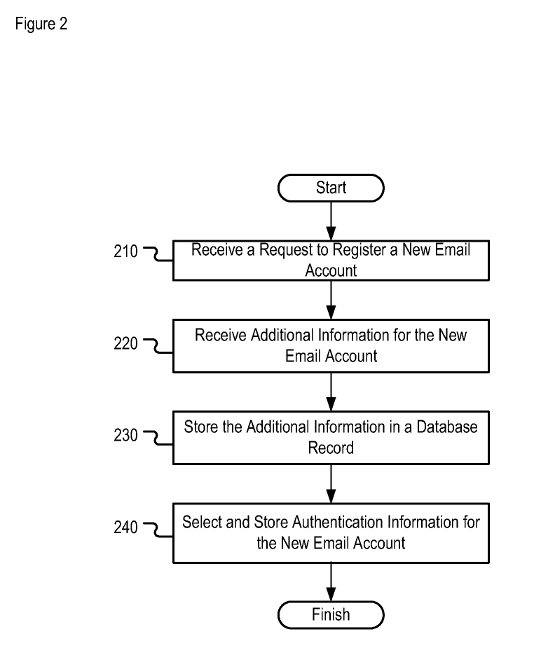

FIG. 2 depicts a flowchart of the salient tasks associated with the operation of the illustrative embodiment of the present invention. It will be clear to those skilled in the art, after reading this disclosure, how to perform the tasks associated with FIG. 2 in a different order than represented or to perform one or more of the tasks concurrently. Furthermore, it will be clear to those skilled in the art, after reading this disclosure, how to make and use alternative embodiments of the present invention that omit one or more of the tasks.

At task 210, server 140 receives a request from user 101, transmitted from terminal 110, to register a new email account. In accordance with the illustrative embodiment, the request comprises an indication of the email identifier which user 101 wishes to register. In accordance with the illustrative embodiment, the desired uniform email identifier is “user_101_new_email,” but it will be clear to those skilled in the art that the requested identifier can be any alphanumerical string.

At task 220, server 140 receives additional information needed for the registration of the new email account. In accordance with the illustrative embodiment of the present invention, server 140 receives the legal name of user 101, address, employment, and credit card number, but it will be clear to those skilled in the art, after reading this disclosure, how to make and use alternative embodiments of the present invention in which server 140 receives any information concerning user 101 or the new email account, such as, for example, and without limitation, geographic location of user 101, professional affiliation of the user, type of electronic device with which the email account is going to be used (e.g. netbook, smart phone, etc.), and so forth.

At task 230, server 140, in a well-known fashion, creates an information record containing the information received at task 220 and stores it in a database.

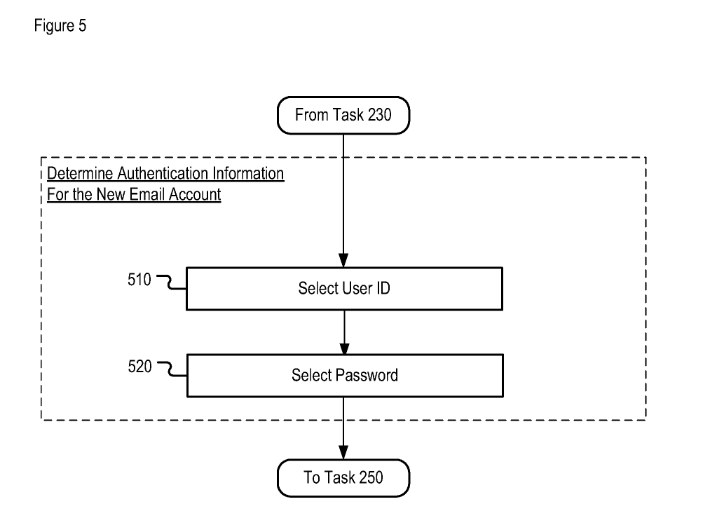

At task 240, server 140 selects the authentication for the new email account. In accordance with the illustrative embodiment of the present invention, the authentication information comprises a user ID and a password, wherein the user ID is an alphanumerical string, such as a user name, that is not as confidential as the password. In any event, it will be clear to those skilled in the art, after reading this disclosure, how to make and use alternative embodiments of the present invention in which the authentication information comprises any type of information capable of being used for authentication purposes, such as user name, telephone number, Social Security number, answer to a security question, etc. Task 240 is further described in the discussions with respect to FIGS. 5, 6, 7, 8, and 9.

FIG. 3 depicts a schematic diagram of the salient components of the illustrative embodiment of the present invention. The illustrative embodiment comprises database table 310.

Database table 310 is a collection of records of data that is stored on server 140. Database table 310 comprises record 320-i, wherein iε{1, 2, 3, 4}.

Record 320-i is a database record that contains authentication information for the uniform resource identifiers (URIs) registered with server 140. In accordance with the illustrative embodiment, record 320-i relates a user ID with a digest based on the user ID and password. The content of record 320-i is further described in the discussion with respect to FIG. 4.

FIG. 4 depicts a schematic diagram of the salient components of the illustrative embodiment of the present invention. The illustrative embodiment comprises record 320-1, field 410, and field 420.

Field 410 contains an indication of a user ID for an email account that is registered with server 140.

Field 420 contains a digest of the user ID stored in field 310, a password, and a hashing function H. The digest is a string based on the user ID, password, and a hashing function. The string is obtained by executing hashing function H(<identifier>,<password>) which implements the MD5 hashing algorithm. It will be clear to those skilled in the art, after reading this disclosure, how to make and use alternative embodiments of the present invention in which other irreversible hashing algorithms are used, such as, for example, and without limitation, SHA-1, PANAMA, HAVAL, MD4, and so forth. Although, the digest is based only on the user ID stored in field 420 and a password, it will be clear to those skilled in the art, after reading this disclosure, how to make and use alternative embodiments of the present invention in which the digest is based on any of the information received at task 220.

FIG. 5 depicts a flowchart of the salient tasks associated with the performance of task 240. It will be clear to those skilled in the art, after reading this disclosure, how to perform the tasks associated with FIG. 5 in a different order than represented or to perform one or more of the tasks concurrently. Furthermore, it will be clear to those skilled in the art, after reading this disclosure, how to make and use alternative embodiments of the present invention that omit one or more of the tasks.

At task 510, user 101 selects the user ID for the new email account which user 101 requested server 140 to register at task 210. In accordance with the illustrative embodiment of the present invention, the user ID is identical to the email account identifier (i.e. email handle). However, it will be clear to those skilled in the art, after reading this disclosure, how to make and use alternative embodiment of the present invention in which the user ID is any alphanumerical string that is distinct from the email account identifier.

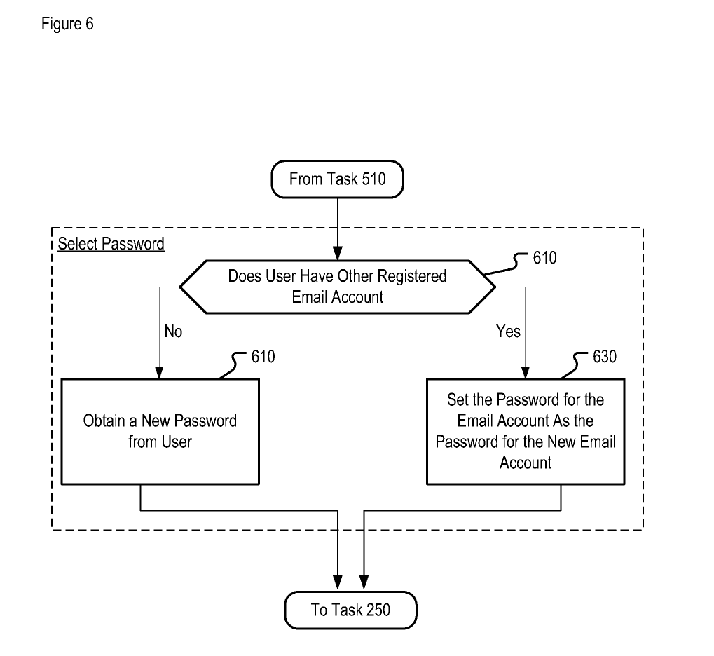

At task 520, server 140 determines the password for the new email account. Task 520 is further described in the discussion with respect to FIG. 6.

FIG. 6 depicts a flowchart of the salient subtasks associated with the performance of task 520. It will be clear to those skilled in the art, after reading this disclosure, how to perform the tasks associated with FIG. 6 in a different order than represented or to perform one or more of the tasks concurrently. Furthermore, it will be clear to those skilled in the art, after reading this disclosure, how to make and use alternative embodiments of the present invention that omit one or more of the tasks.

At task 610, server 140 determines whether user 101 has another email account registered with server 140 by searching a database that relates email accounts with the legal names of their owners. However, it will be clear to those skilled in the art, after reading this disclosure, how to make and use alternative embodiments of the present invention in which server 140 transmits a query to terminal 110 asking the user whether he or she has any other email accounts registered. Furthermore, it will be clear to those skilled in the art, after reading this disclosure, how to make and use alternative embodiments of the present invention in which server 140 uses any other item of information available in the information records for the email accounts registered with server 140, in order to find email accounts that are owned by user 101. If server 140 finds another email account that is owned by user 101, server 140 executes task 630. Otherwise, server 140 proceeds to execute task 620.

At task 620, server 140 asks user 101 to submit a password for the new email account.

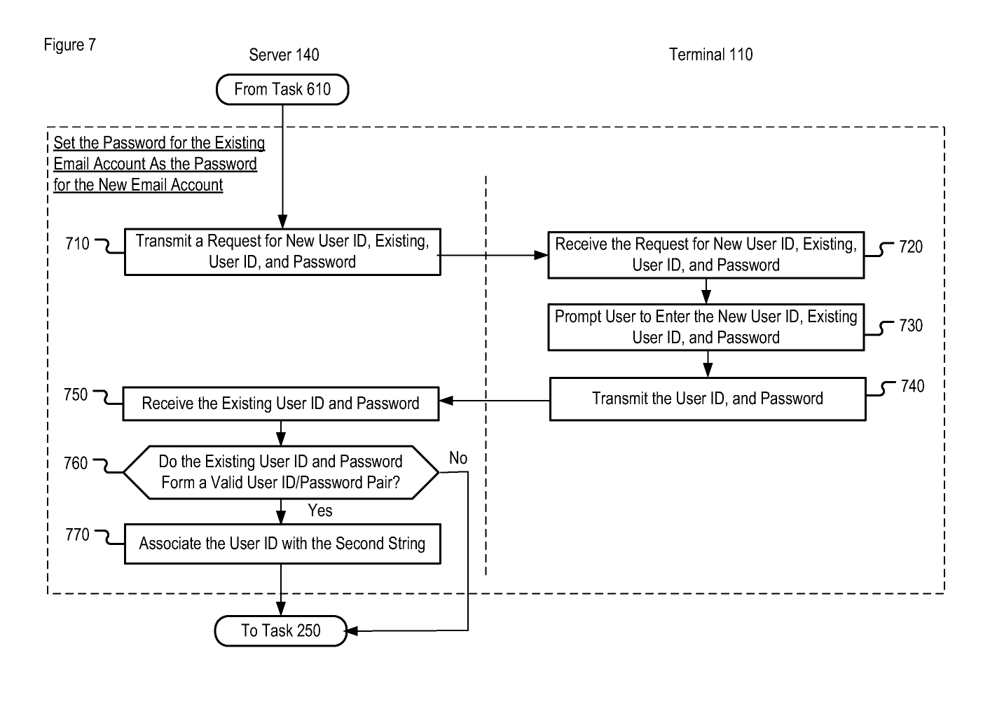

At task 630, server 140 associates the password for the existing email account with the user ID for the new email account. By doing so, server 140 causes the password for the existing email account to also become the password for the new email account. Task 630 is further described in the discussion with respect to FIGS. 7, 8 and 9.

FIG. 7 depicts a flowchart of the execution of the salient sub-tasks associated with the performance of task 630 in accordance with a first illustrative embodiment of the present invention. It will be clear to those skilled in the art, after reading this disclosure, how to perform the tasks associated with FIG. 7 in a different order than represented or to perform one or more of the tasks concurrently. Furthermore, it will be clear to those skilled in the art, after reading this disclosure, how to make and use alternative embodiments of the present invention that omit one or more of the tasks.

At task 710, server 140 transmits a request to terminal 110 for the user ID for the existing email account, found at task 610, and the password associated with the user ID for the existing email account. It will be clear to those skilled in the art, after reading this disclosure, how to make and use alternative embodiments of the present invention in which server 140 requests the password only.

At task 720, terminal 110, in a well-known fashion, receives the request transmitted at task 710.

At task 730, terminal 110 prompts user 101 to enter the requested information.

At task 740, terminal 110, transmits the user ID for the existing email account and the password associated with it in clear text over an encrypted channel. It will be clear to those skilled in the art how to make alternative embodiment of the present invention in which the user ID and password are encrypted before being transmitted. And still furthermore, it will be clear to those skilled in the art, after reading this disclosure, how to make and use alternative embodiments of the present invention in which the user ID and password are transmitted over an unencrypted channel.

At task 750, server 140 receives the user ID for the existing email account and its corresponding password.

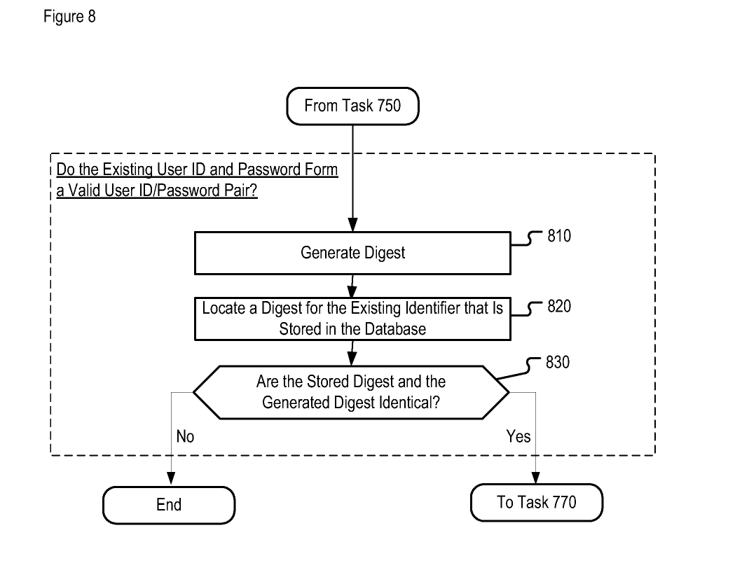

At task 760, server 140 determines whether the user ID for the existing email account and the password form a valid user ID/password pair. Task 760 is further described in the discussion with respect to FIG. 8.

At task 770, server 140 associates the password for the existing user ID with the user ID for the new email account. Server 140 generates a digest based on the user ID for the new email account and the password for the existing email account. The digest is a string based on the user ID, password, and a hashing function. The string is obtained by executing hashing function H(<identifier>,<password>) which implements the MD5 hashing algorithm. It will be clear to those skilled in the art how to make and use alternative embodiments of the present invention in which other irreversible hashing algorithms are used, such as, for example, and without limitation, SHA-1, PANAMA, HAVAL, MD4, and so forth. Finally, server 140 creates a new record in database table 310, and, then, server 140 stores the user ID for the new email account in field 410 and the digest that is based on the user ID for the new email account and the password for the existing email account in field 420.

FIG. 8 depicts a flowchart of the execution of the salient tasks subtasks associated the performance of task 760. It will be clear to those skilled in the art, after reading this disclosure, how to perform the tasks associated with FIG. 8 in a different order than represented or to perform one or more of the tasks concurrently. Furthermore, it will be clear to those skilled in the art, after reading this disclosure, how to make and use alternative embodiments of the present invention that omit one or more of the tasks.

At task 810, server 140 generates a (digest) string from the existing user ID and password received at task 750. More specifically, the string is a digest value obtained by executing hashing function produced H(<existing identifier>, <password>) which implements the MD5 hashing algorithm. However, it will be clear to those skilled in the art how to make and use alternative embodiments of the present invention in which other irreversible hashing algorithms are used, such as, for example, and without limitation, SHA-1, PANAMA, HAVAL, MD4, and so forth. Furthermore, in accordance with the illustrative embodiment of the present invention, the string is a digest of a user ID and password, but it will be clear to those skilled in the art, after reading this disclosure, how to make and use alternative embodiments of the present invention in which the string is a digest based on a password only. And still furthermore, it will be clear to those skilled in the art, after reading this disclosure, how to make and use alternative embodiments of the present invention in which in which the string is a digest based on any additional information present in the information records for the existing email account that are stored at server 140.

At task 820, server 140 locates a record in database table 310 that relates the existing email account with a stored digest value. In particular, server 140 searches the records in database table 310 for a record in which field 410 contains the user ID for the existing email account. When the record is found, server 140 retrieves the digest stored in field 420 of the found record.

At task 830, server 140 compares the digest value calculated at task 810 to the digest retrieved at task 820. If the two digest are identical, server 140 proceeds to execute task 770.

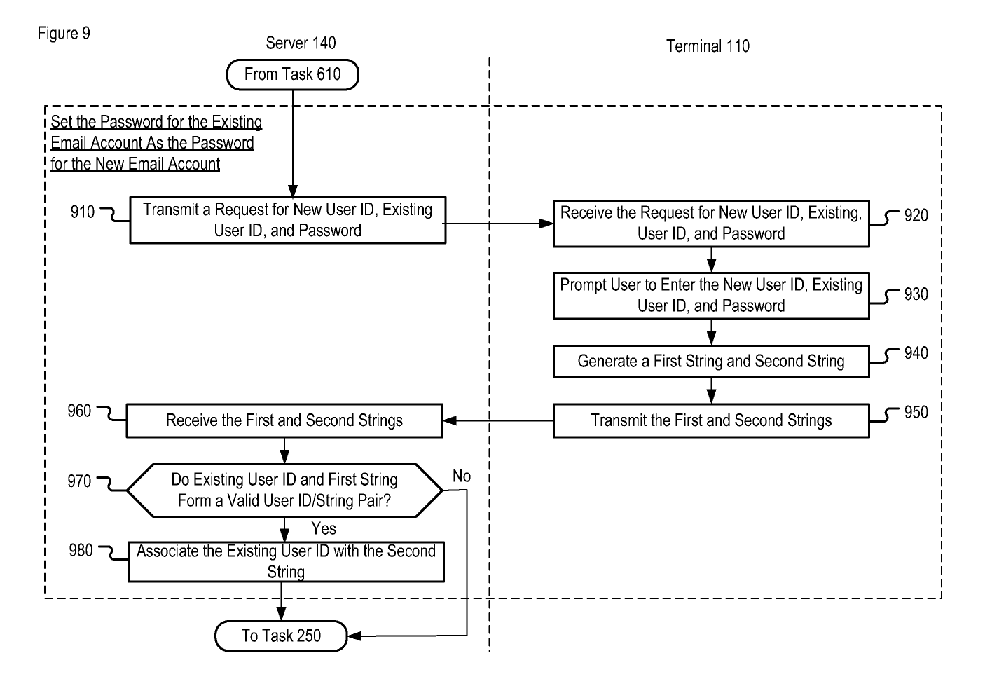

FIG. 9 depicts a flowchart of the execution of the salient sub-tasks associated with the performance of task 630 in accordance with a second illustrative embodiment of the present invention. It will be clear to those skilled in the art, after reading this disclosure, how to perform the tasks associated with FIG. 9 in a different order than represented or to perform one or more of the tasks concurrently. Furthermore, it will be clear to those skilled in the art, after reading this disclosure, how to make and use alternative embodiments of the present invention that omit one or more of the tasks.

At task 910, server 140 transmits a request to terminal 110 for the user ID for the existing email account, the password associated with user ID for the existing email account, and the user ID for the user ID for the new email account.

At task 920, terminal 110 receives the request transmitted at task 910.

At task 930, terminal 110 prompts user 101 to enter the information specified by the received request.

At task 940, terminal 110 obtains the user ID for the existing uniform email account, the password associated with a user ID for the existing email account, and the user ID for the new email account. Terminal 110 uses the received information to generate a first string and a second string. The first string is a digest based on the user ID for the new email account, password for the existing email account, and a hashing function. More specifically, the first string is obtained by executing hashing function H(<new identifier>,<password>) which implements the MD5 hashing algorithm. Similarly, the second string is a digest based on the user ID for the existing email account, password for the existing email account, and the hashing function. The second string is also obtained by executing hashing function produced H(<existing identifier>,<password>) which implements the MD5 hashing algorithm. In accordance with the illustrative embodiment of the present invention, the first string and second string are digests that are based on both a user ID and a password, but it will be clear to those skilled in the art, after reading this disclosure, how to make and use alternative embodiments of the present invention in which the strings are digests that are based on a password only. Furthermore, it will be clear to those skilled in the art, after reading this disclosure, how to make and use alternative embodiments of the present invention in which the strings are digests that are based on any additional information presents in the database records for the new email account, created at task 230, and/or the database records for the existing email account. And still furthermore, it will be clear to those skilled in the art, after reading this disclosure, how to make and use alternative embodiments of the present invention in which terminal 110 generates a third string (secondary digest), which is a digest of the second string and a nonce received from server 140.

At task 950, terminal 110, in a well-known fashion, transmits the first string, second string, user ID for the new email account, and user ID for the existing email account to server 140. It will be clear to those skilled in the art, after reading this disclosure, that in the alternative embodiments of the present invention in which server 110 generates a third string (secondary digest), terminal 110 transmits the third string.

At task 960, server 140, in a well-known fashion, receives the information transmitted at task 950.

At task 970, determines whether the user ID for the existing email account and the second string form a valid user ID/string pair. Server 140 searches the records in database table 310 for a record in which field 410 contains the user ID for the existing email account. Then, if such record is found, server 140 compares the second to the string stored in field 320 of the same record. If the strings match, server 140 proceeds to execute task 980.

It will be clear to those skilled in the art, after reading this disclosure, that in the alternative embodiments of the present invention in which server 110 generates a third string (secondary digest), server 140 generates a verification string (verification digest) based on the string stored in field 320 and copy of the nonce on which the third string (secondary digest) is based. After the verification string (verification digest) is generated, server 140 compares it to the third string (secondary digest).

At task 980, server 140 associates the first string with the new user ID for the new uniform resource identifier. In accordance with the illustrative embodiment, server 140 creates a new record in database table 310, and, then, server 140 stores the user ID for the new email account in field 410 of the created record and the first string in field 420 of the created record.

It is to be understood that the disclosure teaches just one example of the illustrative embodiment and that many variations of the invention can easily be devised by those skilled in the art after reading this disclosure and that the scope of the present invention is to be determined by the following claims. Furthermore, it is to be understood that although, the illustrative embodiments pertain to the assignment of passwords for new identifiers, the same principles can be applied to the changing of the passwords for already existing identifiers.

What is claimed is:

1. A method comprising:
receiving:
i. a first user ID for a first account,
ii. a password, and
iii. a second user ID for a second account; and
associating the second user ID and password with the second account when and only when the first user ID and the password have already been associated with the first account.

2. The method of claim 1 wherein the first user ID and second user ID are associated with the same user.

3. The method of claim 1 wherein:
the first user ID, the second user ID, and the password are received at a Session Initiation Protocol registrar; and
the first user ID is an user ID that is registered with the Session Initiation Protocol registrar.

4. The method of claim 1 wherein the first user ID is a Session Initiation Protocol uniform resource identifier.

5. The method of claim 1 wherein the second user ID is a Session Initiation Protocol uniform resource identifier.

6. The method of claim 1 wherein the first request is made in response to receiving a second request for the registration of a second user ID.

7. The method of claim 1 wherein the first user ID is associated with a user, the method comprising receiving a second request for the registration of the second user ID.

8. The method of claim 1 comprising:
receiving a second request from a user to register the second user ID; and
determining the existence of the first user ID.

9. The method of claim 1 wherein the hashing function is irreversible.

10. The method of claim 1 wherein the associating of the first user ID with the password comprises generating a string based on the first user ID, the password, and a hashing function and storing the string in a database.

11. The method of claim 1 wherein the first request is for the first user ID, the second user ID, and the password.

12. A method comprising:
transmitting a request for:
i. an first user ID, wherein the first user ID is already registered.
ii. a password, and
ii. a second user ID;
receiving a first string and a second string, wherein:
i. the first string is based on: the first user ID, the password, and a hashing function, and
ii. the second string is based on: the second user ID, the password, and the hashing function; and
associating the second string with the second user ID, if the second identifier and the first string form a valid user ID/string pair.

13. The method of claim 12 wherein the first user ID is a Session Initiation Protocol uniform resource identifier.

14. The method of claim 12 wherein the second user ID is a Session Initiation Protocol uniform resource identifier.

15. The method of claim 12 wherein the request for the first user ID, the password, and the second user ID, is made in response to receiving a request to register the second identifier.

16. The method of claim 12 wherein the first user ID is associated with a user, the method comprising receiving a request from the user to register second user ID.

17. The method of claim 12 comprising:
receiving a request from a user to register the second user ID; and
determining the existence of the first user ID.

18. The method of claim 12 wherein the hashing function is irreversible.

19. The method of claim 12, wherein:
the second user ID, the first user ID, and the password are entered by a user into a client application; and
the first string and the second string are generated by the client application.
